(19) United States
(12) Patent Application Publication
(10) Pub. No.: US 2002/0138764 A1
(43) Pub. Date: Sep. 26, 2002

(54) System and method for an automatic license facility

(76) Inventors: Bruce A. Jacobs, Winfield, IL (US); Jacco M.A. Pleijter, Chicago, IL (US); Benjamin L. Rose, Chicago, IL (US)

Correspondence Address: SHAW PITTMAN LLP, 1650 TYSONS BOULEVARD, MCLEAN, VA, 22102, US

(21) Appl. No.: 10/059,251

(22) Filed: Jan. 31, 2002

Related U.S. Application Data
(60) Provisional application No. 60/265,351, filed on Feb. 1, 2001.

(51) Int. Cl. H04L 9/32

(52) U.S. Cl. 713/201

(57) ABSTRACT

An automatic software license facility operates as an intermediary between software buyers and vendors. It allows software buyers, via predefined rules associated with the software, to easily, instantly and securely purchase or obtain authorization to use software licenses. For both buyers and vendors the automatic software license facility provides increased efficiency and convenience, a stronger strategic relationship, decreased administrative burden and costs of software asset management, better reporting and better payment facilities. In a preferred embodiment, a trusted third party operates the facility.

This application claims the benefit of U.S. Provisional Application No. 60/265,351 filed Feb. 1, 2001, which is herein incorporated by reference in its entirety.

### BACKGROUND

1. Field of the Invention

The present invention is directed generally to systems and methods for monitoring and tracking software usage. More particularly, the present invention is directed to an automatic license facility that employs a trusted third party to keep track of, monitor, permit and restrict usage of software applications by individuals and enterprises.

2. Background of the Invention

Generally, software is sold along with a license under which the buyer of the software is permitted to use the software and sometimes copy the software for archival/backup purposes. Software sales to corporations or other large enterprises might include the exchange of a single copy of a piece of software and an agreement with respect to license terms, e.g., how many users may use the software at any given time. Thus, the sale of software typically involves some sort of contractual relationship between buyers and vendors of software. In this context there is often unclarity, even mutual suspicion, among buyers and vendors of software regarding the actual use of a particular vendor's software by a particular buyer or user of that software. This is particularly so with corporations and other large enterprises that have several hundred or even thousand potential users of software (although even individual users have the same concerns). From the vendor's perspective, there is presently no real way to know exactly how many software licenses are being or have been used at any given time by an organization. It is not that buyers are unwilling to divulge use information in an effort to save money by not acknowledging actual use. Indeed, most large corporations are aware of and concerned with the risks of failing to pay for a sufficient number of software licenses, especially when the corporation might be subject to an audit that could uncover the fact that the corporation is not in compliance with software license agreements. Often times, corporations simply lack the tools and the means to actually determine how they are or have used software. As a result, some corporations actually buy more licenses than they actually need simply because they cannot monitor usage.

In addition, it has been estimated that up to 1 in 4 software packages used within business is used illegally or, as such use is sometimes referred to, pirated. Software piracy not only impacts those who create the software. It impacts jobs, wages and retail sales. Software piracy also has a negative effect on the economy in terms of substantial lost tax revenues each year from lost original sales. In addition, organizations may innocently purchase counterfeit or pirated software that can result in a host of serious technical and legal problems.

From the buyer's perspective, there is a reluctance to allow multiple vendors to monitor internal software usage. In addition to the potential disruption of operations, there is concern that vendors are not impartial. Therefore, there is a need for a system and method for facilitating enterprise licenses of software.

### SUMMARY OF THE INVENTION

In view of the foregoing state of affairs in regard to controlling the proliferation and use of software, it is an object of the present invention to provide a system and method for controlling and/or authorizing and/or monitoring the right to use a particular software package.

It is also an object of the present invention to employ a trusted third party (i.e. a party that is neither the vendor nor the user of the software, but is trusted by both of these parties) in the context of the software vendor/user relationship that can impartially control, authorize and/or monitor the right to use software packages.

It is a further object of the present invention to provide a regime in which the overuse of one or more licenses leads to the triggering of a previously negotiated secondary set of license terms.

It is also an object of the present invention to administer an agreed-upon licensing structure negotiated between a software buyer and vendor.

It is yet another object of the present invention to provide usage reports to at least one of a software buyer and a software vendor.

It is another object of the present invention to associate a value to one or more licenses so that different licenses can be traded for one another.

It is also an object of the present invention to compile and aggregate software usage data with respect to one or more enterprises in an effort to generate value added information that can be presented and/or sold to software vendors and/or buyers and/or others.

These and other objects of the present invention are achieved by the implementation of an automatic license facility (ALF) that addresses the concerns of both software vendors and buyers and that is operated by a trusted third party that controls, monitors, tracks and accounts for software licenses that are necessary to utilize software. As used herein, a “license” means the right to use software or the right to have a software application activated and/or available for use.

More specifically, in accordance with the present invention the trusted third party associates with individual copies of software predetermined rules, i.e., a license, thereby giving an entity the right to use or activate the software, and when a user intends to utilize the software, the trusted third party is so notified and can thereafter control whether the user can indeed obtain access to that particular software application. That is, the trusted party captures information regarding software utilization and compares that information against existing licensing contracts between a user (e.g., software buyer, renter, licenser) and a software vendor. Information can be captured using well-known electronic wrapping techniques or via monitoring agents, like that disclosed in U.S. Pat. No. 5,675,510. Information capture can occur in real time via an always-on connection to the trusted third party, or can occur more periodically via a periodic connection to the trusted third party.

With the collected information it is also possible to provide additional services to both buyers and vendors of software. For example, if a corporation exceeds its licensed allocation, the trusted third party can implement whatever terms of a previously-negotiated contract might be triggered. In this way a vendor can always be assured that it is being paid properly for the use of the software that it has sold.

Another aspect of third party software license control according to the present invention is that the third party can administer any form of agreed-upon licensing structure. That is, some licenses are restricted to particular users or particular servers. Such conditions can easily be accommodated by the trusted third party by applying the license rules associated with the software. Thus, by changing the rules and referencing them in appropriate ways, it is possible in accordance with the present invention to support multiple license schemes for any given piece of software. For example, consider the case where there is one license for a particular software program, which is limited to one person in a project for 3 months. When the project is over, that person is no longer eligible to use that particular software anymore. Via the trusted third party, however, a second license for that software can be delivered (or made available) to someone else in the organization, who can then use the license for, e.g., another 3 months.

The systems and methods of the present invention, namely, the automatic license facility (ALF), permits a much more flexible way of managing licenses. One way to understand this management technique is to analogize the handling and monitoring of software licenses to a bank account of licenses, via which licenses can be debited and credited to an account by the trusted third party. In other words, the user (i.e., corporation or enterprise) maintains a “license account,” which is run by the trusted third party in accordance with, e.g., an application service provider (ASP) model or a fully business outsourced solution model, and preferably employs the Internet or other electronic network to monitor the actual utilization of software by users.

The following example illustrates one particular use of the present invention. A buyer anticipates that it will need 10,000 licenses of a vendor's software, enterprise wide. Instead of only buying the software in the conventional manner (i.e., buying 10,000 copies of the application or loading one application on a server that can be shared by 10,000 people), the trusted third party uploads the buyer's account with 10,000 licenses and, via monitoring by electronic wrapping, monitoring agents, etc., ensures that the users of the software never exceed the 10,000 licenses. More specifically, a central clearinghouse (the trusted third party) monitors the use of the software in light of rules defined for the software, manages a user's account and also activates or deactivates access to the software application as necessary in accordance with the particular license terms.

A byproduct of being a trusted third party is the ability to aggregate software usage information that can be resold to both vendors and users of the software products that are controlled by the trusted third party. This information is of interest to both buyers and vendors because these entities do not necessarily have easy access to such information. That is, certain information on buying and selling behavior of companies in certain industries can “mined” from the data that can be obtained through operation of a trusted third party regime.

Still further, the present invention can provide essential reporting functions to the buyers, for instance. A total overview, somewhat like a bank statement of the total users, can be supplied to a buyer on demand, or on a periodic basis. Additionally, the present invention can be used in conjunction with conventional on-site auditing as a confirmation tool or, because both the vendor and buyer agree that the trusted third party has the “final word” on any discrepancies, the present invention can completely replace conventional on-site auditing.

Yet another aspect of the present invention is that the business rules associated with the software can include a “valuation” of the software. Thus, for example, licenses for different software packages can act like different “currencies” with predetermined exchange rates and the use of one particular software package is not necessarily worth the same as the use of a second software package. Thus, multiple copies of licenses for the same or different software packages can be exchanged for one another, all in accordance with their respective valuations. Valuation of the software licenses can vary depending on how the software is installed on an enterprise's servers, time of day, number of intended users, or any number of other factors.

The present invention can preferably operate within a regime in which buyers and vendors negotiate among themselves and agree to license terms which are then turned into the business rules that are applied to software usage. On the other hand, the present invention is also well suited to sell software directly to buyers with predetermined license terms, whereby a buyer need not even engage a vendor, but instead needs only to contact the trusted third party.

Thus, as is evident from the foregoing, the present invention is directed to a scheme in which a trusted third party manages the “right of use” of software. Alternatively, the present invention can be said to provide “right of use management” for software via a trusted third party.

The present invention is applicable to a broad range of applications, namely, software management of devices and applications, a clearinghouse functionality for the entire software industry, as well as applications of the system to industries beyond software.

(1) Software Management of all Kinds of Devices and Applications

With the development and maturity of the technology powering the automatic licensing facility (ALF), the system can be applied to a broader set applications and devices—beyond packaged software installed on a PC or server. For instance, clearing usage of software residing on mobile devices (phones, PDA's, etc.) is also considered to be within the range of opportunities for ALF.

(2) A Clearinghouse for the Software Industry

In its most developed form, ALF can act as a clearinghouse for the software industry comparable to the existing “brick-and-mortar” clearing houses for futures, options and equities. Intermediaries such as distributors and resellers act as the clearing members of this software clearing house. Clearing of software can utilize the techniques described herein as well as those commonly employed in the offline world, including cross-margining, swaps and options.

(3) Application of ALF to New Industries and Technologies

ALF can also provide a well-developed asset management tool not only for applications, but also for data. The system can be applied to new industries to monitor usage of both static data (e.g., analyst reports, research reports, books, education material, etc.) and dynamic data (e.g., online streaming data, financial price quotes & news feed, entries in databases, etc.).

### BRIEF DESCRIPTION OF THE DRAWINGS

FIG. 1 illustrates an exemplary arrangement of the parties involved in the present invention.

FIG. 2 is a flow chart illustrating and exemplary process in accordance with the present invention.

FIGS. 3-5 illustrate, respectively, different function levels that the trusted third party may undertake in accordance with the present invention.

### DETAILED DESCRIPTION OF THE INVENTION

As described above, software vendors often feel that buyers do not buy sufficient licenses for the software that is used. Further, lack of impartial measurement techniques leads to mistrust between buyers and sellers of software. As a consequence large corporate buyers, in particular, have high levels of anxiety over software license compliance. Further, buyers often feel they have limited negotiating power with sellers over the number of licenses due to the mistrust. The present invention addresses these fundamental issues and consequently provides a higher level of trust between buyers and vendors.

In accordance with a significant aspect of the present invention, an automatic license facility (ALF) is provided as a secure facility for software license management and administration services. With this system, software buyers can securely and efficiently request licenses for software from participating software vendors. The usage is registered on an ‘ALF license account’, which resembles a bank account, where licenses are the equivalent of “currency.” In a preferred implementation of the invention, ALF operates as an intermediary between software buyers and vendors and allows software buyers to easily, instantly and securely manage software assets at a central site on an electronic network, such as the Internet.

One of the most prominent values of ALF is that a trusted third party, such as a bank, large accounting firm or university for example, is involved as an intermediary between software vendors and software buyers. Additionally, buyers and vendors benefit from cost reductions by utilising ALF as the primary platform of license management. Also, ALF provides a software management vehicle with strong reporting capabilities and value-added functionalities such as online payment options, improved customer satisfaction and convenience. To a certain extent, ALF can even decrease software piracy, although it is not designed as a direct solution to this problem.

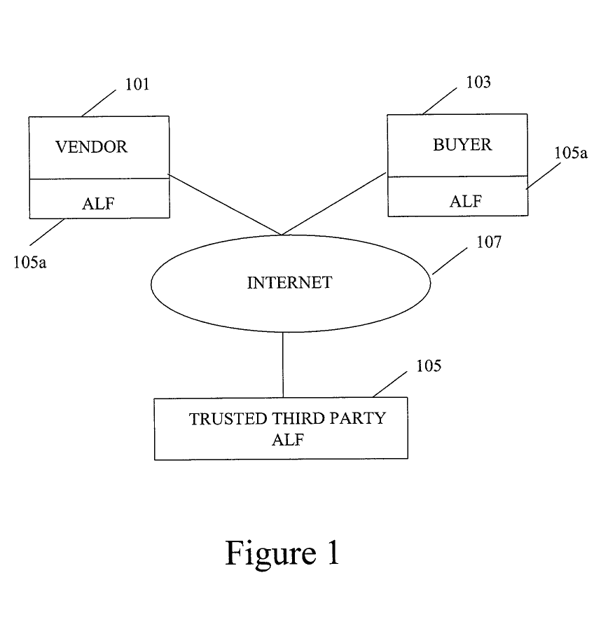

FIG. 1 illustrates an exemplary arrangement of the parties involved in the present invention. As shown, a software vendor 101, software buyer 103 and a trusted third party 105 that runs the automatic license facility (ALF) are in communication with each other via an electronic network, such as the Internet 107. Those skilled in the art will appreciate, however, that any electronic network including local area networks (LANs), wide area networks (WANs), wireless networks, and the like, could be employed to transfer information among the parties, and that the illustration of the Internet is exemplary only and not meant to limit the scope of the present invention.

Although not necessarily a preferred implementation for, e.g., security reasons, the functionality of ALF 105a could be physically located at a software vendor site or a software buyer site. That is, at least portions of the software underlying the functionality of ALF could be stored on a computer/server that is co-located with vendor or buyer servers. However, as mentioned, for reasons of security and trust it is preferable that a separate entity that is not a user of the software itself performs the functions and controls the software underlying ALF.

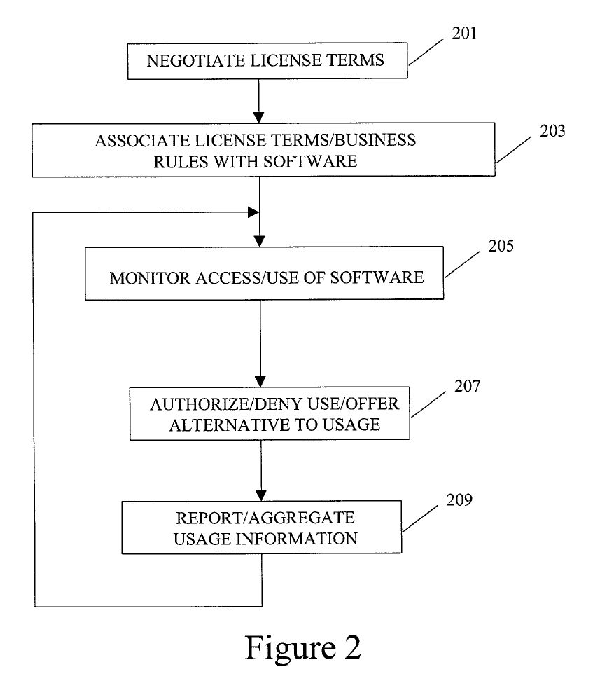

FIG. 2 is a flow chart illustrating and exemplary process in accordance with the present invention. In this exemplary process, vendor 101 and buyer 103 negotiate terms of a software license for a particular piece of software, step 201. Such terms can include pricing, how many simultaneous users are permitted, time of day that use is permitted, a relative value associated with software package (e.g., a number from 1-10), etc. Then, using well-known electronic techniques such as those employed for digital rights management and content rights management (e.g., wrapping, monitoring agents, etc.), the software for which the license was negotiated is digitally associated with the license terms and/or business rules that flow from the negotiated license terms, step 203. Then, as shown at step 205, ALF monitors the access and use of the software via, e.g., well-known network communication techniques (e.g., Internet Protocol) to communicate that access to and/or use of the licensed software package has been requested. This information is communicated, over the Internet 107, to trusted third party 105 that operates ALF.

Then, at step 207, ALF authorizes access or use, denies access or use, or perhaps offers an alternative plan for permitting access or use of the software package, depending on the circumstances. Finally, at step 209, the usage data is collected, stored, aggregated as desired, and when appropriate, reported to at least one of software vendor 101, software buyer/user 103 and/or a third party. In the steady state, the process repeats steps 205, 207 and 209 as long as software licenses are believed to be available for use by a user.

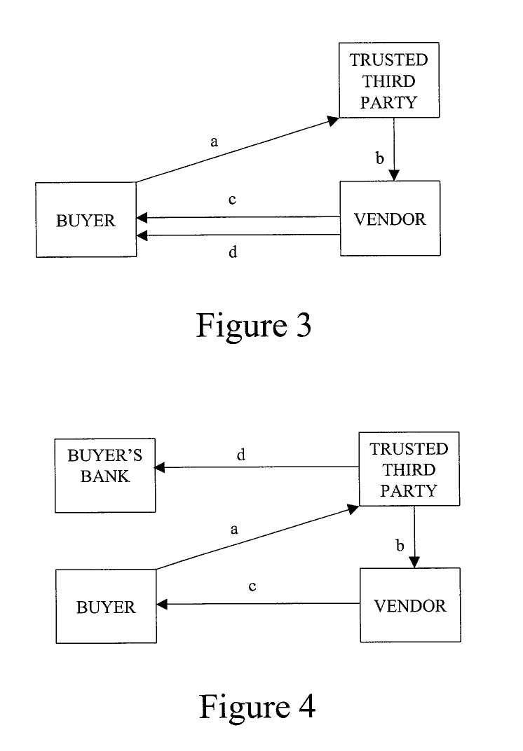

FIGS. 3-5 illustrate possible scenarios or business models in accordance with which the trusted third party may preferably involve itself in the overall software license and usage transaction between vendor 101 and buyer 103. Specifically, there are three primary functions:

| | |
|---|---|
| Function 1: | Keeping software usage accounts, maintained in licenses |
| | or other software ‘currencies’ |
| Function 2: | Pricing, invoicing and payment services |
| Function 3: | License key distribution |

Different combinations of these services could be made into different service models, allowing three different levels of outsourcing of activities to the vendor. FIG. 3 illustrates a first model in which function 1 is undertaken by trusted third party 105 and functions 2 and 3 are undertaken by vendor 101. In this model, a vendor uses ALF for the sole purpose of having users centrally register their license purchases. It is therefore mainly a shared administration system for both parties. Its value comes from the fact that costs are reduced, standardized reporting is provided and a software usage ‘bank statement’ becomes the unquestioned basis for contract re-negotiation. Information flows as follows, as shown in FIG. 3.

a. License request from buyer to trusted third party

b. After validation and account check, trusted third party informs vendor

c. Vendor distributes key

d. Vendor invoices

FIG. 4 illustrates a second model in which functions 1 and 2 are undertaken by trusted third party 105 and function 3 is undertaken by vendor 105. This model takes outsourcing one step further, and allows trusted third party 105 to take care of the financial transactions of the license purchase. Typically, vendors with complicated key generation algorithms, or efficient key generation/distribution processes, would opt for this model. Information flows as follows, as shown in FIG. 4.

a. License request from buyer to trusted third party

b. After validation and account check, trusted third party informs vendor

c. Vendor distributes key

d. Trusted third party invoices and/or handles payment

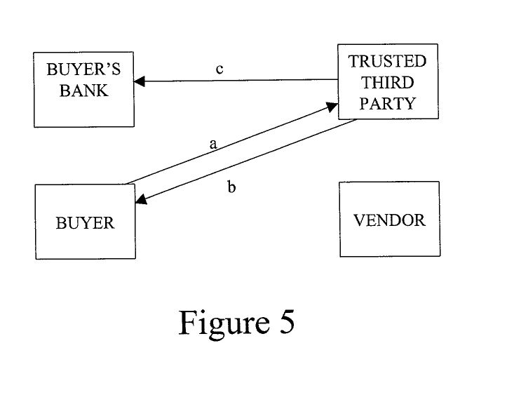

FIG. 5 shows the case wherein trusted third party 105 undertakes all of functions 1, 2 and 3 and the vendor undertakes none. In this model, trusted third party 105 also distributes a license key in addition to the account keeping and financing services. It is noted, of course, that license key generation algorithms may vary per vendor, and can range from straightforward to very complex. This particular model suits vendors desiring to have their license management function fully outsourced to a trusted third party. Typically, smaller vendors would opt for this model for cost and efficiency reasons. However, larger vendors could also be interested in this model, perhaps after having initially experienced model 1 or 2 first. Information flows as follows, as shown in FIG. 5.

a. License request from buyer to trusted third party

b. After validation and account check, trusted third party distributes key

c. Trusted third party invoices and/or handles payment

As will be appreciated by those skilled in the art, the present invention provides several significant features/services: (i) software utilization metering and monitoring, (ii) software compliance, (iii) research data and (iv) software procurement/distribution mechanism between vendor and buyer.

With respect to software utilization, metering and monitoring, the present invention, through, e.g., software wrapping and automated communication over, e.g., the Internet, a trusted third party can keep track of, for example, how many pieces of software are operating at a given time, how many pieces and which pieces of software are operating over a given time period, who is operating the software, which computers are operating the software, etc., and generating reports related to such gathered information.

With respect to software compliance, data from the utilization, metering and monitoring aspect of the invention is preferably matched against the number or type of licenses that a particular user (e.g., enterprise) might have negotiated for. That is, software compliance is a form of license policing, which can take one or more of several forms. For example, if a user attempts to access a piece of software for which there is no current or available license, a window could be made to be displayed on the user's computer indicating that he has no rights to use that piece of software and that he should contact his system administrator to coordinate how to obtain access to that software.

Alternatively, license policing (using the same scenario outlined above) could take the form of offering to the user the opportunity to rent or buy the software that is desired. The entire financial transaction is preferably initiated by the license terms associated with the software in question. Still another way of policing is to simply permit access to the software, indicate to the user that even though he has no specific rights to use the software, the vendor is permitting use in this particular instance. Of course, via the software utilization, metering and monitoring services of the present invention, ALF can still accurately track who is using the piece of software and how many times the software is being or has been used.

The following is a more complete, though not exhaustive, list of business models for license usage:

Perpetual and renewable license to use

Pay-per-use (rental)

Try first and then pay

Free usage (vendors rely on advertising sales)

Free intellectual property

In connection with the foregoing, pricing of software licenses can be a combination of many parameters including, but not limited to:

Per name user

Per concurrent user

Per CPU

Per server

Per site, location or company

Value based, including schemes tied to transaction volumes per period

Based on data collected and stored as a result of services (i) and (ii), it is possible to generate useful research data that can then be sold to vendors, buyers, or other groups having an interest in such information. Research data preferably includes, but is not limited to, usage data and purchasing habits.

Finally, the present invention provides a seamless software procurement model and integrated distribution mechanism that is supported by a trusted third party, whereby it is possible, e.g., to avoid shipping diskettes or CD-ROMs on which software is traditionally stored and to avoid the sometimes adversarial relationship in which software vendors and buyers often find themselves.

In view of the foregoing, the present invention provides at least the following significant advantages to software buyers:

Highly accurate compliance measurement

Ability to compare actual software usage data to contracted number of licenses:

Reconcile actual software usage to vendor invoice statements

Provide proof of compliance to auditors, vendors, etc.

Provide company with piece of mind

Receive additional audit services

Reduced Costs/Optimization of Software Assets

Ability to use accurate software data to:

Reduce internal costs associated with software management

Reduce number of unused licenses (Redeployment)

Perform more accurate spend monitoring for cost & management accounting

Accurate Information for Contract Negotiation

Ability to use accurate software usage data to:

Minimize tension between buyer and seller over measurement standards

Reduce the amount of time spent negotiating contracts

Enable New Software Procurement Models

Ability to deploy and manage new software procurement models such as:

Payment related-to-use models, i.e. pay per use or trial basis

E-procurement where licenses are purchased on an as needed basis

The present invention also provides at least the following significant advantages to software vendors:

Reduced Costs

Reduced costs related to monitoring and enforcing compliance (e.g. audits)

Reduced research/data collection costs associated with renegotiating contracts

Reduced costs related to license distribution and management

Increased Revenue

Through accurate usage data, buyers will pay for what they use

Improve relationship management, i.e. auto-alerting customers when more licenses are needed/required

Access to Aggregated Market Data

Improved understanding of customer behaviors and market trends

Improved marketing and deployment models

Improved Financing & Administration

Electronic Invoice Presentment & Payment (EIPP)

Automated financing services

Enable New Software Procurement Models

Pay-per-use

Free/discounted trial period

Trusted third party players also reap significant benefits from the present invention, including:

Generating revenue from buyers through annual subscription fees for core ALF services.

Offering supplemental fee-based services to software buyers and sellers, including license audits, and digital right compliance management.

Establishing strategic marketing partnerships with a few major business service providers to efficiently acquire customers.

The market segment in which ALF can likely add the most value is mid range and desktop systems in large (>1000 employees) and very large (>5000 employees) enterprises (although individual users may also benefit). The software products in this business segment are typically referred to as “packaged business applications” and consist of packaged software for functional areas such as finance & accounting; manufacturing & logistics; human resources; customer management, etc.

Although ALF has been described primarily thus far in the context of desktop and laptop software usage, ALF is also applicable to other fields including:

Mobile telephone licensing;

Licensing of prepaid mobile phone cards;

Payments with mobile phone;

Release prepaid balance on mobile telephone using wrapped “licenses”;

There are several ways to charge users and vendors for the use of ALF software asset management and electronic license delivery functionality. One is to charge a percentage on the vendor revenue streams flowing through ALF from the vendor and/or the user. However, since there can be many different business models in use by vendors, it is sometimes difficult to establish a sound basis for pricing that is aligned with these software vendor models. Therefore, in one possible implementation of the invention, both buyers and vendors are charged for the various services ALF delivers. Revenue drivers used in ALF preferably include set-up fees, annual subscription fees and transaction fees for hosted contracts, licenses distributed and number of ALF enabled PC/servers.

In summary, the automatic license facility of the present invention is particularly valuable in that ALF operates as an intermediary between software buyers and vendors. It allows software buyers to easily, instantly and securely purchase software licenses at a central site on, e.g., the Internet. For both buyers and vendors, this provides ample value: increase of efficiency and convenience, increase of strategic relationship, decrease of the administrative burden and costs of software asset management, better reporting and better payment facilities.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method of controlling software usage, comprising the steps of:
(a) associating at least one predetermined rule with a software package;
(b) receiving an indication of an attempt by a user to access the software package; and
(c) comparing the indication to at least one predetermined rule, wherein at least step (c) is performed by a trusted third party.

2. The method of claim 1, wherein step (b) comprises monitoring access via at least one of electronic wrapping and an agent.

3. The method of claim 1, further comprising selecting, in view of step (c), at least one of (i) authorizing the use of the software package, (ii) denying use of the software package, (iii) offering an alternative usage plan for the software package and (iv) acknowledging compliance with the at least one predetermined rule.

4. The method of claim 1, wherein the user and the trusted third party are in communication with each other via an electronic network.

5. The method of claim 1, wherein the software vendor, user and trusted third party are in communication with one another via an electronic network.

6. The method of claim 1, wherein the at least one predetermined rule corresponds to a term of a license for the software package.

7. The method of claim 1, wherein the software vendor and user negotiate terms of a software package license and the terms are incorporated into the wrapper.

8. The method of claim 1, further comprising collecting software package usage data.

9. The method of claim 8, further comprising reporting to at least one of the software vendor and the user the software package usage data.

10. The method of claim 1, further comprising generating a software package usage statement.

11. The method of claim 1, wherein the at least one predetermined rule comprises a valuation of the software package.

12. The method of claim 1, further comprising employing software package usage data to monitor software license compliance.

13. The method of claim 1, wherein the software package operates on at least one of a computer and a mobile communications device.

14. A method of providing confidence in software license compliance by involving a trusted third party in a software vendor/user transaction, the method comprising the steps of:
(a) identifying a vendor-generated software package to which user access should be restricted unless a software license is available;
(b) associating at least a portion of terms of the software license with the software package;
(c) monitoring for attempts to access the software package;
(d) determining for each attempt to access the software package whether access should be granted or denied based on the at least a portion of the license terms; and
(e) collecting and storing data related to the granted and denied access,
wherein at least steps (c)-(e) are performed by a third party that is trusted by both the software vendor and software user and is different from both the software vendor and software user.

15. The method of claim 14, wherein the third party is at least one of a bank, an accounting firm and a university.

16. The method of claim 14, wherein the user and the third party are in communication with each other via an electronic network.

17. The method of claim 16, wherein the electronic network comprises the Internet.

18. The method of claim 14, wherein the software vendor, user and third party are in communication with one another via an electronic network.

19. The method of claim 14, wherein the software vendor and user negotiate terms of the software license that are incorporated into the wrapper.

20. The method of claim 14, further comprising aggregating data from a plurality of users.

21. The method of claim 14, further comprising reporting the data to at least one of the software vendor and the user.

22. The method of claim 14, further comprising generating a software package usage statement.

23. A method of coordinating the authorized use of a software package, comprising the steps of:
(a) establishing a trusted third party vis-a-vis a software package vendor and a software package user;
(b) detecting when the software package user accesses the software package;
(c) determining whether the software package user has a valid software license to be authorized to use the software package; and
(d) permitting use of the software package by the user if it is determined by the trusted third party that the user has a valid software license.

24. The method of claim 23, wherein the trusted third party comprises at least one of a bank, an accounting firm and a university.

25. The method of claim 23, wherein the detecting step (b) comprises employing at least one of (i) an electronic wrapper that is associated with the software package and (ii) a monitoring agent.

26. The method of claim 25, wherein at least the software package user and the trusted third party are in communication with each other via an electronic network.

27. The method of claim 23, wherein the software package vendor and software package user negotiate terms of the software license without the involvement of the trusted third party.

28. The method of claim 23, further comprising offering an alternative software package usage plan to the user in the event the user does not have a valid software license.

29. The method of claim 23, further comprising collecting and storing data related to software package usage.

30. The method of claim 29, further comprising confirming compliance with a software license agreement.

31. The method of claim 29, further comprising offering a statement of usage to at least the software package user.

32. The method of claim 29, further comprising arranging for payment for usage of the software package via the trusted third party.

33. A method for managing software licenses, comprising the steps of:
(a) receiving software usage data that is representative of use of a software package;
(b) comparing the software usage data to at least one predetermined software usage rule that is representative of a software license term or condition for the software package;
(c) determining whether the software usage data is in compliance with the software license term or condition by comparing the software usage data with the at least one predetermined software usage rule; and
(d) at least one of (i) acknowledging compliance of the software usage with the software license term or condition, (ii) authorizing usage of the software package, (iii) denying usage of the software package, (iv) charging a fee for usage of the software package and (v) aggregating the software usage data,
wherein at least step (b) is performed by a trusted third party.
